(19) United States
(12) Patent Application Publication
(10) Pub. No.: US 2024/0296496 A1
(43) Pub. Date: Sep. 5, 2024

(54) METHOD FOR PROVIDING INFORMATION, PROGRAM, AND NON-TRANSITORY COMPUTER-READABLE STORAGE MEDIUM

(71) Applicant: PostPrime Inc., Tokyo (JP)

(72) Inventor: Daniel Kei TAKAHASHI, Tokyo (JP)

(73) Assignee: PostPrime Inc., Tokyo (JP)

(21) Appl. No.: 18/300,082

(22) Filed: Apr. 13, 2023

(30) Foreign Application Priority Data
Mar. 2, 2023 (JP) 2023-032295

(51) Int. Cl. G06Q 40/04; G06Q 30/0203

(52) U.S. Cl. CPC G06Q 40/04; G06Q 30/0203

(57) ABSTRACT

A technique for providing information regarding an investment topic is provided. A method for providing information regarding an investment topic for user terminals includes transmitting, using the server, a prediction entry part including a vote input part for generating vote data regarding a price movement of one or more investment topics to each of the user terminals, receiving the vote data from the user terminals, generating vote result data, which is a result of comparison between upward movement predictions and downward movement predictions based on the vote data received from the user terminals, and transmitting a second screen area including the vote result data to the user terminal. The vote data includes either an upward movement prediction, which indicates a price increase of the one or more investment topics, or a downward movement prediction, which indicates a price decrease of the one or more investment topics.

This application claims priority under 35 U.S.C. § 119 to Japanese Patent Application No. 2023-032295, filed Mar. 2, 2023, which is incorporated by reference.

### BACKGROUND OF THE INVENTION

### 1. Field of the Invention

Disclosure in the present application relates to a technique for providing information regarding an investment topic.

### 2. Description of the Related Art

When an investor makes an investment decision on a stock issue, for example, the investor refers to various investment decision indicators related to the stock issue. Especially today, anyone can easily obtain a great deal of information on various investment topics, such as stocks, bonds, foreign currencies, virtual currencies, and futures trading, through the Internet. Extensive past and present quantitative and qualitative information can be referenced as investment decision indicators, and the amount thereof is enormous. Japanese Unexamined Patent Application Publication No. 2004-29882 proposes a system for notifying a customer of stocks that meet criteria for stock investment indicators requested by the customer.

### SUMMARY OF THE INVENTION

The present disclosure, therefore, provides a technique for providing information regarding an investment topic.

A first aspect of the present disclosure is a method for providing information regarding an investment topic for user terminals using a server. The server transmits a first screen area including a vote input part for generating vote data regarding a price movement of one or more investment topics to each of the user terminals. The server receives the vote data from the user terminals. The vote data includes either an upward movement prediction, which indicates a price increase of the one or more investment topics, or a downward movement prediction, which indicates a price decrease of the one or more investment topics. The server generates vote result data, which is a result of comparison between upward movement predictions and downward movement predictions based on the vote data received from the user terminals. The server transmits a second screen area including the vote result data to the user terminal.

Behind users' voting for their predictions on price movements of investment topics are changes in various investment decision indicators that the users have learned about. There are natural limits, however, to quantity and quality of information that can be collected by individual investors (users) and appropriateness of the investors' interpretations of the collected information. In other words, because it is impossible for individual investors to increase their information sensitivity and interpretation ability beyond their personal cognitive limits, it is desirable to be able to provide information provision services that can efficiently support individual investors' information gathering. According to the first aspect of the present disclosure, each user can know, as vote result data, results of predictions (upward movement predictions or downward movement predictions) made by a large number of users (user terminals) regarding price movements of investment topics. A trend of the users' predictions can be an opportunity for each user to notice oversights of important information, overestimation or underestimation of information, and the like. Each user can thus use predictions made by a large number of other users for his/her own investment decisions.

The vote result data included in the second screen area may include one or more vote percentages indicating the upward movement predictions and the downward movement predictions in one or more voting periods prior to a time of voting. Since a user terminal can obtain vote percentage, a user who uses the user terminal can know predictions made by a large number of other users (user terminals) regarding price movements of investment targets.

The one or more voting periods may include, for example, 24 hours leading up to a time of voting (24 hours prior to the time of voting), 7 days leading up to the time of voting (7 days prior to the time of voting), 30 days leading up to the time of voting (30 days prior to the time of voting), or any other period prior to the time of voting. The user may set the period prior to the time of voting using the user terminal.

The “time of voting” refers to a time when the user votes using the user terminal. More specifically, the “time of voting” may be a time when the server stores, in a storage unit thereof, vote data received from the user terminal, a time when a voting operation is performed using an input unit of the user terminal, a time when the server receives vote data from the user terminal, or any other time set by the server.

The vote result data may include a vote percentage chart indicating changes in the one or more vote percentages in the one or more voting periods. A user who uses a user terminal can easily understand, from the vote percentage chart, temporal changes in predictions (prediction trend) made by a large number of other users (user terminals).

The first screen area may include a predicted value entry part, where a predicted value of the one or more investment topics is entered. In this case, specific predicted values of investment topics can be collected from a large number of users (user terminals). The collected predicted values can be used by a large number of users (user terminals) as reference information for investment decisions.

The predicted value entry part may include a prediction reason entry part, where a prediction reason for the predicted value is entered. In this case, prediction reasons for upward movement predictions or downward movement predictions can be collected from a large number of users (user terminals). The collected prediction reasons can be used by a large number of users (user terminals) as reference information for investment decisions.

The second screen area may include another user prediction display part including another user prediction information, which includes the predicted value and the prediction reason from one or more other users. In this case, not only vote result data but also predicted values and prediction reasons entered by other users, which are more specific information, can be known. A user (user terminal), therefore, can collect perspectives of other investors' investment decisions.

Furthermore, the server may display a plurality of pieces of the another user prediction information included in the another user prediction display part while sorting the plurality of pieces of the another user prediction information newest first or oldest first, in ascending or descending order of evaluation of a user, and/or in ascending or descending order of a predicted value. In this case, convenience of information gathering can be increased for a user.

Furthermore, the server may receive a notification setting from each of the user terminals, the notification setting including a lower limit value or an upper limit value of the one or more vote percentages in the one or more voting periods, and transmit a notification to the user terminal on a basis of the notification setting. Furthermore, the server may receive a notification setting from each of the user terminals, the notification setting including a lower limit value or an upper limit value of the predicted value, and transmit a notification to the user terminal on a basis of the notification setting.

Changes in predictions made by a large number of users regarding price movements (changes in upward movement predictions and downward movement predictions) can be caused by changes in some investment decision indicators, such as business performance, growth materials for the future, politics, economic indicators, international conditions, social conditions, incidents, and natural disasters. It is extremely difficult, however, for individual investors (users) to collect various investment decision indicators in a timely manner. By making it possible to grasp changes in thinking of a large number of users (user terminals) regarding price movement predictions (changes in upward movement predictions and downward movement predictions, changes in vote percentage, and changes in predicted values) in real time through notifications, individual investors (users) can quickly and easily access the events that have occurred.

Furthermore, the server may receive a notification setting from each of the user terminals, the notification setting including reception, by the server, of the vote data from one or more other users, and transmit a notification to the user terminal on a basis of the notification setting. In this case, a user can know, for example, that a particular user he/she is focusing on has voted, and can use this as an opportunity to consider his/her own investment decisions.

Furthermore, the server may receive a notification setting from each of the user terminals, the notification setting including reception, by the server, of the predicted value from one or more other users, and transmit a notification to the user terminal on a basis of the notification setting. In this case, a user can know, for example, that a particular user he/she is focusing on has entered a predicted value, and can use this as an opportunity to consider his/her own investment decisions.

Furthermore, the server may receive a notification setting from each of the user terminals, the notification setting including reception, by the server, of a prediction reason for the predicted value from one or more other users, and transmit a notification to the user terminal on a basis of the notification setting. In this case, a user can know, for example, a reason for a predicted value entered by a particular user he/she is focusing on, and can use this as an opportunity to consider his/her own investment decisions.

The notification may include at least an audio notification, a notification through transmission of an email, or a notification based on an image in a website screen or an application screen or a text message. In this case, a user terminal can certainly recognize reception of a notification.

The notification may include at least a notification, to a website screen, an application screen, or a screen of each of the user terminals, based on a movie or an animation where a human character or an anthropomorphic character speaks. In this case, since the notification is a movie or an animation where a human character or an anthropomorphic character speaks, a user pays more attention to the notification.

A second aspect of the present disclosure is a program causing a computer to operate as a server that provides information regarding an investment topic for user terminals, the program including instructions to perform a process including transmitting a first screen area including a vote input part for generating vote data regarding a price movement of one or more investment topics to each of the user terminals, receiving the vote data from the user terminals, the vote data including either an upward movement prediction, which indicates a price increase of the one or more investment topics, or a downward movement prediction, which indicates a price decrease of the one or more investment topics, generating vote result data, which is a result of comparison between upward movement predictions and downward movement predictions based on the vote data received from the user terminals, and transmitting a second screen area including the vote result data to the user terminal.

A third aspect of the present disclosure is a non-transitory computer-readable storage medium storing a program causing a computer to operate a server that provides information regarding an investment topic for user terminals, the program including instructions to perform a process including transmitting a first screen area including a vote input part for generating vote data regarding a price movement of one or more investment topics to each of the user terminals, receiving the vote data from the user terminals, the vote data including either an upward movement prediction, which indicates a price increase of the one or more investment topics, or a downward movement prediction, which indicates a price decrease of the one or more investment topics, generating vote result data, which is a result of comparison between upward movement predictions and downward movement predictions based on the vote data received from the user terminals, and transmitting a second screen area including the vote result data to the user terminal.

According to the second and third aspects of the present disclosure, each user can use predictions made by a large number of other users for his/her own investment decisions.

According to the aspects of the present disclosure, information useful for investors to make investment decisions can be provided.

### BRIEF DESCRIPTION OF THE DRAWINGS

In order to clearly describe an aspect of the present disclosure on the basis of an exemplary embodiment, drawings necessary for the description will be briefly described. The drawings merely illustrate some embodiments, and do not limit the scope of the present disclosure. Those skilled in the art can obtain drawings of other related embodiments on the basis of the drawings in the present disclosure without using any special inventive ability.

FIG. 1 is a diagram illustrating the configuration of an information processing system according to an aspect of the present disclosure.

FIG. 2 is a block diagram illustrating the configuration of a computer apparatus according to the aspect of the present disclosure.

FIG. 3 is a diagram illustrating the functional configuration of a server according to the aspect of the present disclosure.

FIG. 4 is a diagram illustrating the functional configuration of a user terminal according to the aspect of the present disclosure.

FIG. 5 is a diagram illustrating an information display screen according to the aspect of the present disclosure.

FIG. 6 is a flowchart illustrating a method for providing information according to the aspect of the present disclosure.

FIG. 7 is a diagram illustrating topic display areas according to the aspect of the present disclosure.

FIG. 8 is a flowchart illustrating another method for providing information according to the aspect of the present disclosure.

FIG. 9 is a diagram illustrating other topic display areas according to the aspect of the present disclosure.

FIG. 10 is a diagram illustrating a notification screen according to the aspect of the present disclosure.

FIG. 11 is a diagram illustrating a notification setting screen for an investment topic according to the aspect of the present disclosure.

FIG. 12 is a diagram illustrating a notification setting screen for a user group according to the aspect of the present disclosure.

### DESCRIPTION OF THE PREFERRED EMBODIMENTS

An aspect of the present disclosure will be described with reference to the drawings on the basis of an exemplary embodiment. The following embodiment does not unreasonably limit the content of the present invention described in the claims. Not all components described in the present embodiment are necessarily essential as solutions provided by the present invention.

All embodiments and selectable embodiments included in the present disclosure may together form new embodiments through any combinations thereof. All technical features and selectable features included in the present disclosure may together form new technical features through any combinations thereof.

A term “or” herein is used as an inclusive term. “A or B”, for example, means “A, B, or both A and B”. “A”, “B”, and “both A and B” each satisfy “A or B”.

“First”, “second”, and “n-th (n is a natural number)” are used herein and in the claims to distinguish different elements, and are not intended to indicate certain order or superiority. The same components are given the same reference numerals between embodiments, and redundant description thereof is omitted.

Terms “up”, “down”, “front”, “back”, “left”, and “right” used herein and in the claims and a direction or a positional relationship expressed by words including at least one of these terms are based on the drawings, and only used to describe the embodiments conveniently and briefly. Unless clearly defined or limited, therefore, these terms are not intended to state, explicitly or implicitly, that a certain element or use thereof is oriented in a certain direction or limit the claims and the embodiments.

Values and elements qualified by a term such as “about”, “approximately”, “substantially”, or “essentially” used herein and in the claims should be each understood as including the value and some values around the value or the element and other elements regarded as the same as the element. “About 3”, for example, may include 3 and values contiguous to 3, insofar as technical features and technical significances claimed by the present disclosure are not deviated from. In the case of “A is essentially the same as B”, “essentially” implies not only a perfect match between A and B but also A and B different from each other, insofar as the technical features and the technical significances claimed by the present disclosure are not deviated from.

A term “unit” used herein and in the claims may include a “functional unit” achieved by, for example, a combination of one or more pieces of hardware and one or more pieces of software executed by the one or more pieces of hardware. Hardware resources such as a server and user terminals described herein and in the claims may each be achieved by a single apparatus or two or more apparatuses communicably connected to each other.

Information (a program, content, data, etc.) to be processed in the following embodiments is expressed by differences in signal values as a set of binary bits including 0s and 1s, and a signal processing circuit included in one or more pieces of hardware processes and communicates the information.

Here, a signal processing circuit refers to a circuit achieved by combining together one or more circuits, one or more portions of circuitry, one or more processors, one or more memories, and/or the like and may be an application-specific integrated circuit (ASIC), a programmable logic device (e.g., a simple programmable logic device (SPLD) or a complex programmable logic device (CPLD)), a field-programmable gate array (FPGA), or the like.

A method for processing information, a method for providing information, an information provision system, an information provision service, a program (a program for providing information), a non-transitory computer-readable storage medium according to an aspect of the present disclosure will be described hereinafter.

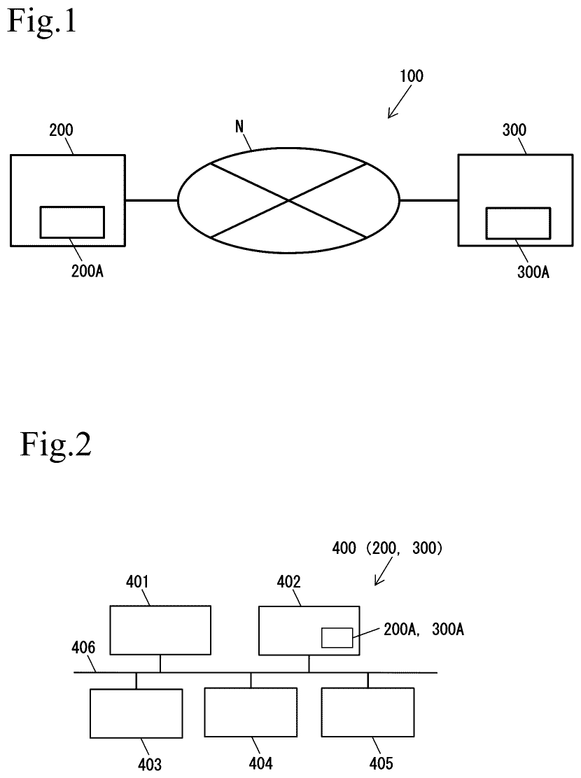

### [1] Configuration of Information Provision System (FIG. 1)

As illustrated in FIG. 1, an information provision system 100 according to the aspect of the present disclosure is achieved by a server 200. The server 200 provides an information provision service for user terminals 300. The user terminals 300 are each configured to be able to communicate with the server 200 over a communication network N and can use the information provision service provided by the server 200. The reference numeral “300” will be used herein and in the drawings not only for the term “user terminals” but also for each “user terminal” included in the user terminals 300.

The information provision system 100 is configured as a community for sharing information regarding investment topics. The term “investment topics” used herein and in the claims are “investment targets”, namely, for example, foreign currencies (United States (U.S.) dollar, dollar/yen, Australian dollar/yen, pound/yen, euro/yen, Canadian dollar, Swiss franc, Chinese yuan, Hong Kong dollar, New Zealand dollar, Indian rupee, etc.), commodity futures (gold, silver, palladium, platinum, copper, iron ore, crude oil, soy oil, gasoline, natural gas, coffee, wheat, rice, sugar, cocoa, soybean, etc.), domestic stock indices, foreign stock indices, bonds, and virtual currencies. Users can transmit, to the server 200 using the user terminals 300, posts, votes on price movement predictions, predicted values, and the like, which will be described later, for investment topics of interest thereto and receive information regarding the investment topics provided by the server 200.

FIG. 1 illustrates the server 200 as a single functional block for convenience of description. The server 200, however, may include one or more computer apparatuses 400 (FIG. 2) as hardware resources. The server 200 provides the “information provision service” for the user terminals 300 by executing a program (hereinafter referred to as a “program for providing information”) according to another aspect of the present disclosure.

A program 200A for providing information may be achieved by, for example, a web application. The web application may include a presentation layer, an application layer, and a data layer. In this case, the hardware resources of the server 200 may be achieved by a webserver for constructing the presentation layer, an application server for constructing the application layer, and a database server for constructing the data layer.

The presentation layer may include a client-side program executed by the user terminals 300 and a server-side program executed by the server 200. The client-side program executes, as a user interface of the user terminals 300, an input function, a display function, and the like using, for example, a web browser or an application. The server-side program executes a function of obtaining input data and instructions from the user terminals 300 and a function of outputting display data to the user terminals 300. The application layer is a function executed by the server 200 and, for example, executes instructions from the user terminals 300, processes data, and generates display screens. The data layer is a function executed by the server 200 and, for example, extracts data from a storage device, updates data, and stores data.

FIG. 1 illustrates the user terminals 300 as a single functional block for convenience of description. The user terminals 300, however, include a large number of user terminals 300 communicable with the server 200. The user terminals 300 may be achieved by communicable computer apparatuses 400 (FIG. 2). The computer apparatuses 400 may each be achieved by an information communication apparatus such as a laptop computer, a desktop computer, a tablet terminal, a smartphone, a smartwatch, or a wearable device.

Each user registers himself/herself to the information provision service provided by the server 200 to obtain a user account. User accounts are basically owned by different users (persons). Each user may use one or more user terminals 300. Each user can use the information provision service by entering a user identifier (ID) and a password and logging into his/her user account for each of one or more user terminals 300 used thereby. For example, each user can use the information provision service using a smartphone and a laptop computer as user terminals 300.

### [2] Hardware Resources (FIG. 2)

The hardware resources of the server 200 and the user terminals 300 included in the information provision system 100 may each be achieved by one or more computer apparatuses 400. FIG. 2 is a block diagram illustrating the configuration of a computer apparatus 400. The computer apparatus 400 may include, for example, a control device 401, a storage device 402, an input device 403, an output device 404, a communication device 405, and a data transmission channel 406.

The control device 401 is a central processing unit (CPU) and executes the program for providing information. The control device 401 controls operation of the entirety of the computer apparatus 400 in order to cause the computer apparatus 400 to function as the server 200 or a user terminal 300.

The storage device 402 includes one or more read-only memories (ROMs), random-access memories (RAMs), and/or external storage devices. The storage device 402 stores various programs including the program for providing information and data to be processed by the various programs.

The input device 403 includes one or more keyboards, mouses, and/or touch panels.

The output device 404 may include one or more display devices and/or speaker devices.

The communication device 405 controls communication with other computer apparatuses 400 including the server 200 over the communication network N.

The data transmission channel 406 is a signal line shared by the control device 401, the storage device 402, the input device 403, the output device 404, and the communication device 405 to communicate data. The data transmission channel 406 may be achieved by circuit wiring in a circuit board, cabling, or a wireless link.

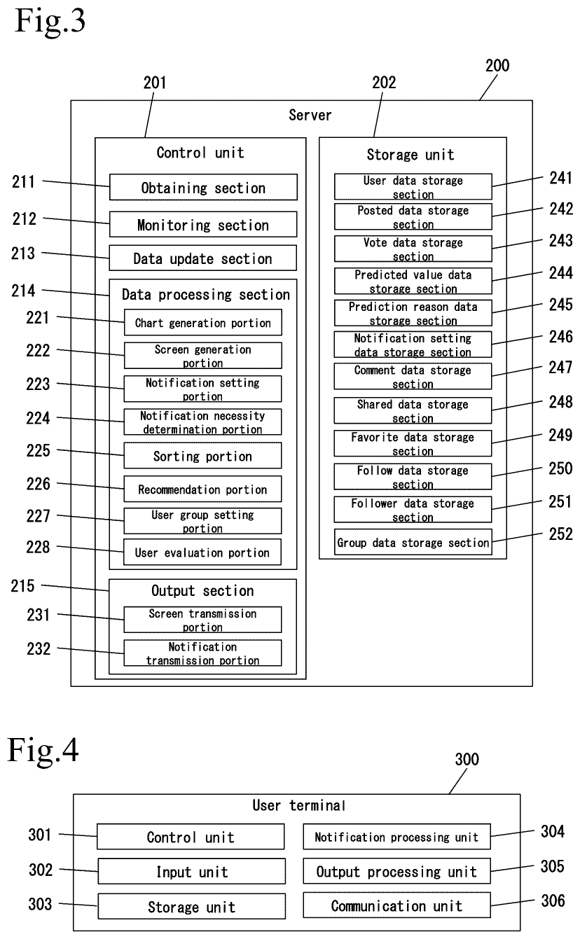

### [3] Functional Configuration of Server 200 (FIG. 3)

The server 200 includes a plurality of functional units. The server 200 may include a control unit 201 and a storage unit 202. The control unit 201 controls various operations performed by the server 200. The control unit 201 is achieved by executing the program for providing information using the control device 401. The storage unit 202 stores various programs including the program for providing information and data. The storage unit 202 may be achieved by the storage device 402.

### Control Unit 201 [FIG. 2]

The control unit 201 operates as a plurality of functional sections illustrated in FIG. 3. More specifically, the plurality of functional sections may include an obtaining section 211, a monitoring section 212, a data update section 213, a data processing section 214, and an output section 215. An outline of these functional sections will be described hereinafter, and details of the functional sections will be described in later description of operations.

The obtaining section 211 obtains, over the communication network N, data transmitted to the server 200 from the user terminals 300.

The monitoring section 212 monitors presence or absence of update of data accumulated in the storage unit 202. Data to be monitored includes vote data, predicted value data, prediction reason data, and notification setting data obtained by the server 200 from the user terminals 300 and accumulated in the storage unit 202 (FIG. 2).

The data update section 213 updates the data accumulated in the storage unit 202. Data to be updated includes the vote data, the predicted value data, the prediction reason data, and the notification setting data obtained by the server 200 from the user terminals 300 and accumulated in the storage unit 202 (FIG. 2).

The data processing section 214 operates as a plurality of functional portions and processes data. The data processing section 214 includes a chart generation portion 221, a screen generation portion 222, a notification setting portion 223, a notification necessity determination portion 224, a sorting portion 225, and a recommendation portion 226.

The chart generation portion 221 generates various charts displayed on the user terminals 300 and updates the charts in accordance with changes in basic chart data (population data). The chart generation portion 221 may generate charts for each investment topic. More specifically, charts of each investment topic may include, for example, charts, a vote percentage chart, and a predicted value chart.

The charts may include charts provided from external servers and charts independently generated by the chart generation portion 221 on the basis of external data.

The vote percentage chart is a graph generated for each investment topic using a large number of pieces of vote data obtained from the user terminals 300 as population data. The predicted value chart is a graph generated for each investment topic using a large number of pieces of predicted value data obtained from the user terminals 300 as population data. These graphs will be described later.

The screen generation portion 222 generates screens to be displayed on the output device 404, such as a display device, included in each user terminal 300. The screens may be displayable on browsers and applications installed on the user terminals 300. The screens may include one or more charts generated by the chart generation portion 221 and posts obtained from the user terminals 300.

The notification setting portion 223 sets notification conditions for the user terminals 300. The server 200 can identify notification target items whose notification conditions are set for the user terminals 300. The notification target items may include, for example, setting of a predicted value by another user, a median pivot notification, a vote percentage alert, a post or a predicted value being favorited, a post being shared, a comment made on a post, and a user being followed. Notification settings will be further described later.

The notification necessity determination portion 224 determines whether one or more pieces of data to be monitored by the monitoring section 212 correspond to one or more notification conditions set by each user terminal 300.

The sorting portion 225 changes display targets and order of display of a plurality of pieces of data on each user terminal 300 on the basis of display conditions specified by the user terminal 300.

The recommendation portion 226 notifies each user terminal 300 of information of interest to the corresponding user. The information of which each user terminal 300 is notified may be a post, another user, or the like. As described later, a user data storage section 241 includes, as attribute information regarding a user, an occupation, areas of professional expertise, an investment history, and areas of investment expertise. For example, a keyword (or a key phrase) including one or more nouns is extracted from attribute information regarding a user, and other users whose attribute information includes the extracted keyword or a word co-occurring with the extracted keyword, posts by the other users, current news, or the like are identified and determined as “recommendation information”. Each user terminal 300 can be notified of the recommendation information through, for example, a notification including a link for accessing the recommendation information. This method for generating “recommendation information” is an example, and recommendation information can be generated by a statistical method, a method based on machine learning, or the like, instead.

A user group setting portion 227 allows the user of each user terminal 300 to group other users as desired. This grouping function makes it possible to use user group vote notifications and user group prediction notifications, which will be described later. The user of each user terminal 300 can select or cancel selection of other users using, for example, checkboxes for selecting a member of a group in a follow user list screen or a follower user list screen linked from a follow icon in a first display area 501.

A user evaluation portion 228 evaluates user contribution to the community provided by the information provision system 100. User evaluation indices in the present embodiment may include, for example, “interest”, “engage”, and “number of followers”, which will be described later. As described later, these user evaluation indices can be quantified, and the user contribution can be calculated on the basis of the quantified user evaluation indices. As described later, the user evaluation portion 228 can perform “overall evaluation” on the basis of the user evaluation indices. Information regarding the user evaluation indices and the overall evaluation can be displayed in the follow user list screen, the follower user list screen, and the like, which will be described later.

The output section 215 outputs various pieces of data in accordance with how the data processing section 214 has processed data. The outputting may include transmission of data to the user terminals 300 from the server 200 over the communication network N.

The output section 215 may include a screen transmission portion 231 and a notification transmission portion 232.

The screen transmission portion 231 transmits, to the user terminals 300, screen data to be displayed on the user terminals 300, the screen data being generated by the chart generation portion 221, the screen generation portion 222, or the like.

The notification transmission portion 232 transmits a notification to each user terminal 300 on the basis of a result of a determination made by the notification necessity determination portion 224. The notification transmitted by the notification transmission portion 232 may include at least an audio notification, a notification through transmission of an email, or a notification based on an image in website screen or an application screen or a text message. In this case, the user terminals 300 can certainly recognize reception of a notification. The notification transmitted by the notification transmission portion 232 may include at least a notification, to a website screen, an application screen, or a screen of each user terminal 300, based on a movie or an animation where a human character or an anthropomorphic character speaks. In this case, since the notification is a movie or an animation where a human character or an anthropomorphic character speaks, the user pays more attention to the notification.

### Storage Unit 202 [FIG. 2]

The storage unit 202 includes storage sections for various pieces of data that will be described hereinafter. The storage sections may each be configured as a data table.

### User Data Storage Section 241

The user data storage section 241 stores data (account data) regarding accounts registered by users to use the information provision system 100. The account data includes data such as user IDs, usernames (nicknames), email addresses, attribute information, evaluation information, and follow/follower information.

The user IDs are identification codes for uniquely identifying individual accounts in the information provision system 100. Information relating to the individual user terminals 300 is associated with the user IDs.

The usernames (nicknames) are information disclosed in the information provision system 100 to identify the users of the user terminals 300.

The email addresses are registered during the registration of the users and used as address information when a notification is transmitted by email, which will be described later.

The attribute information is user profiles and may include the users' self-introductions, occupations, areas of professional expertise, investment histories, areas of investment expertise, and interests. At least one of these pieces of information can be disclosed to other user terminals 300 depending on user settings.

The evaluation information may include information such as “interest”, “engage”, and “number of followers”. “Interest” is information indicating a level of interest from other users and is an indicator of evaluation by others calculated on the basis of the number of views, the number of favorites (likes), the number of comments, and the number of shares earned, from the other users, by posts made by a user. “Engage” is information indicating how active a user is and is an activity evaluation indicator calculated on the basis of the number of posts made by the user and the number of views, the number of favorites (likes), the number of comments, and the number of shares of the user in relation to posts made by the other users. “Number of followers” is the number of other users following a user.

“Interest” and “engage” may each be expressed by a total value of all evaluation items in a certain period of time, namely one week, one month, or three months, for example, and the users may be ranked in descending order of the total value. Alternatively, each user may be ranked in accordance with percentage of the user's share of the sum of total values of all the users in the certain period of time.

As a result, the overall evaluation, where each user's activity and positive evaluation from the other users are combined together, can be performed for the user on the basis of an “interest” ranking, an “engage” ranking, and “number of followers”. The overall evaluation revitalizes the community and is effective as an indicator of contribution to improvement of quality of information accumulated in the information provision system 100.

An example of the overall evaluation is user ranking. The user ranking may be, for example, any desired type of ranking such as ten-level ranking, five-level ranking, or three-level ranking. In the user ranking, for example, a reference value may be set for each of rankings for “interest”, “engage”, and “number of followers”, and a certain ranking may be given when the three indicators exceed their respective reference values. The certain ranking may be, for example, platinum, gold, silver, or bronze, or a special grade, a first grade, a second grade, or a third grade. Such evaluation information can be disclosed to other user terminals 300.

A user can recognize users beneficial thereto by checking disclosed attribute information and evaluation information regarding other users, and can easily collect information valuable thereto.

### Posted Data Storage Section 242

A posted data storage section 242 stores data (posted data) posted by the user terminals 300 to the server 200. The posted data may include posted data IDs for identifying corresponding pieces of posted data, user IDs of users who posted the data, times of posting, posted text, images, sounds, and movies, and content data including hashtags, as well as user IDs of users who have favorited posts and the number of favorites.

### Vote Data Storage Section 243

The vote data storage section 243 stores data (vote data) regarding the users' votes on predictions of future price movements of investment topics. The vote data may include vote data IDs for identifying pieces of vote data, investment topic IDs for identifying investment topics, user IDs, times of voting, and vote data (upward movement predictions or downward movement predictions). Vote data regarding each vote is either an upward movement prediction or a downward movement prediction. The server 200 can set the times of voting at which the users can vote using the user terminals 300. One or a plurality of voting opportunities, for example, may be provided for each day. It is preferable, however, to provide one voting opportunity per day in order to prevent abuse of prediction opportunities and ensure credibility of user predictions. That is, it is preferable that “one day”, which is used as a unit, be from 00:00:00 to 23:59:59 and a user predict whether a price of an investment topic will rise or fall.

### Predicted Value Data Storage Section 244

A predicted value data storage section 244 stores predicted future values (predicted value data) of investment topics. The predicted value data may include predicted value data IDs for identifying individual predicted values, investment topic IDs for identifying investment topics, user IDs, times of prediction, and predicted values (numerical values). Predicted value data may be set as, for example, a predicted value a certain period of time from present time. More specifically, predicted value data may be a predicted value one week from the present time, a predicted value one month from the present time, a predicted value three months from the present time, or a predicted value a desired period of time from the present time. The server 200 may set a specific time of a predicted value (one week, one month, or three months from the present time, etc.). A time of prediction may be a time when a predicted value is entered on a user terminal 300, a time when the server 200 receives predicted value data from a user terminal 300, or the like.

### Prediction Reason Data Storage Section 245

A prediction reason data storage section 245 stores reasons (prediction reason data) why future values of investment topics have been predicted. The prediction reason data may include prediction reason data IDs for identifying individual prediction reasons, investment topic IDs for identifying investment topics, user IDs, prediction reason times, and prediction reasons. The prediction reason data may be, for example, text data freely written by the users. A prediction reason time may be a time when a predicted value is entered on a user terminal 300, a time when the server 200 receives predicted value data from a user terminal 300, or the like.

### Notification Setting Data Storage Section 246

A notification setting data storage section 246 stores notification settings (notification setting data) relating to investment topics made by the server 200 for the user terminals 300. The notification setting data differs depending on a target of notification settings. The notification setting data will be described later.

### Comment Data Storage Section 247

A comment data storage section 247 stores comments (comment data) given by each user to posts and prediction reasons of the other users. The comment data may include comment data IDs for identifying individual comments, investment topic IDs for identifying investment topics, user IDs, comment target IDs (post IDs, prediction reason IDs, etc.), times of comments, and content of comments. The comments may be, for example, text data freely written by the users.

### Shared Data Storage Section 248

A shared data storage section 248 stores information (shared data) shared by each user with other users. The shared data may include share IDs, post IDs indicating shared posts, user IDs of users who have made shared posts, and times of sharing.

### Favorite Data Storage Section 249

A favorite data storage section 249 stores data (favorite data) regarding evaluations performed by each user on posts made by other users, comments on posts, predicted values, and prediction reasons. The favorite data may include favorited target IDs (post data IDs, comment data IDs, predicted value data IDs, and prediction reason IDs), investment topic IDs for identifying investment topics, user IDs, and times of favorites.

### Follow Data Storage Section 250

A follow data storage section 250 stores data (follow data) for identifying other users each user is following (follow users). The follow data may include user IDs of follower users, user IDs of follow users, and times of following. Follow users can be displayed in the follow user list screen (not illustrated) linked from the follow icon in the first display area 501. The follow user list screen may include, for each follow user, a username, attribute information, evaluation information (“interest”, “engage”, a rating, etc.), a group selection part (user group selection button), a voting notification setting part (a checkbox for enabling or disabling a function of receiving notifications about vote results (upward movement predictions or downward movement predictions) of follow users etc.), and a prediction notification setting part (a checkbox for enabling or disabling a function of receiving notifications about values predicted by follow users and prediction reasons).

### Follower Data Storage Section 251

A follower data storage section 251 stores data (follower data) for identifying other users (follower users) following each user. The follower data may include user IDs of follower users, user IDs of follow users, and times of following. Followers can be displayed in the follower user list screen (not illustrated) linked from the follower icon in the first display area 501. The follower user list screen may include, for each follower user, a username, the attribute information, the evaluation information (“interest”, “engage”, a rating, etc.), a group selection part (user group selection button), a voting notification setting part (a checkbox for enabling or disabling the function of receiving notifications about vote results (upward movement predictions or downward movement predictions) of follower users etc.), and a prediction notification setting part (a checkbox for enabling or disabling the function of receiving notifications about values predicted by follower users and prediction reasons).

### Group Data Storage Section 252

A group data storage section 252 stores data indicating one or more users grouped by each user. One or more groups may be set. Each user can group other users whose investment topics of interest are the same or, on the basis of evaluation information, highly evaluated users, for example, to make it easier to access reliable information relating to the user's investments.

### [4] Functional Configuration of User Terminals 300 (FIG. 4)

The user terminals 300 are each achieved by one or more computer apparatuses 400 as hardware resources and each include a plurality of functional units. The user terminals 300 may each include a control unit 301, an input unit 302, a storage unit 303, a notification processing unit 304, an output processing unit 305, and a communication unit 306.

The control unit 301 executes a client-side program 300A for providing information to control various operations performed by the user terminal 300.

The input unit 302 receives data input by the user. Data to be received is a post, a vote on a price movement prediction, a predicted value, addition of a favorite, or the like.

The storage unit 303 stores a client-side program, screen display data, and the like transmitted from the server 200.

The notification processing unit 304 receives notification settings input on the user terminal 300 and displays notifications received from the server 200 on the user terminal 300 in accordance with the notification settings. The notifications can be issued on an information display screen 500 of the program 300A for providing information or received using emails received by the user terminal 300.

The output processing unit 305 outputs data to the output device 404 of the user terminal 300. The output device 404 is one or more display devices, speaker devices, and/or the like. The information display screen 500 of the program 300A for providing information is displayed on a screen of the display device. Audio data and movie data including sound are output from the speaker device.

The communication unit 306 communicates data with the server 200.

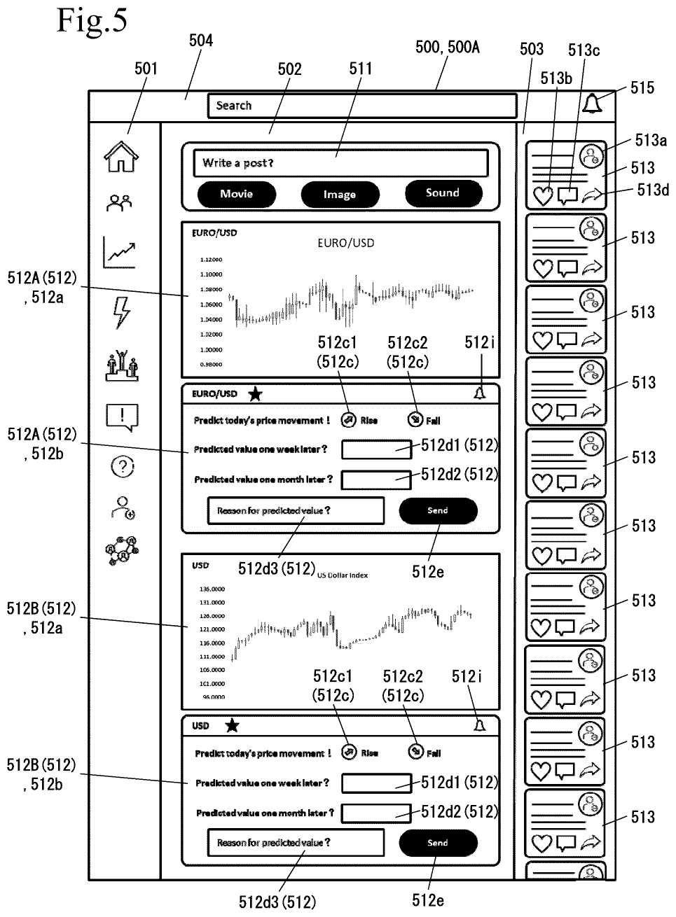

### [5] Example of Configuration of Information Display Screen (FIG. 5)

FIG. 5 illustrates an example of the information display screen 500 achieved by the program 200A or 300A for providing information. The information display screen 500 is displayed on the user terminal 300 as a screen of a browser or an application. The information display screen 500, therefore, may be a webpage or an application screen. The information display screen 500 is a screen with the user logged in with the user terminal 300. The information display screen 500, therefore, is a dedicated screen for each of the user terminals 300.

The information display screen 500 is not a top page but a chart display screen, which will be described later. A chart display screen 500A includes a first display area 501, a second display area 502, and a third display area 503.

### First Display Area 501

In the first display area 501, a plurality of icons with links are displayed. The icons displayed in the first display area 501 are as follows from a top.
Home icon: An icon for displaying a top page
Post icon: An icon for displaying a display screen for a list of posts obtained from the user terminals 300
Chart icon: An icon for displaying a chart display screen for a list of charts of investment topics
Current news icon: An icon for displaying a display screen for a list of current news
Ranking icon: An icon for displaying a display screen for user rankings
Comment icon: An icon for displaying a display screen for a list of other users' comments on posts made by the user
Help icon: An icon for displaying a help page
Follow icon: An icon for displaying a display screen (follow user list screen) for a list of other users followed by the user
Follower icon: An icon for displaying a display screen (follower user list screen) for a list of other users following the user

### Second Display Area 502

The second display area 502 includes a post entry part 511 and topic display areas 512. Although FIG. 5 illustrates only two topic display areas for convenience of description, topic display areas for other investment topics are displayed by scrolling down the screen.

### Post Entry Part 511

The post entry part 511 is provided with a text entry part, where the user can freely enter text. Not only text but also a movie, an image, and a sound can be attached to a post.

### Topic Display Areas 512

The topic display areas 512 illustrated in FIG. 5 include, for example, investment topic charts 512a and prediction entry parts 512b.

In the example illustrated in FIG. 5, an investment topic of first topic display areas 512A is euro/U.S. dollar. An investment topic of second topic display areas 512B is U.S. dollar.

The first topic display areas 512A and the second topic display areas 512B each include a chart 512a and a prediction entry part 512b. The chart 512a can be set for a live chart, or a static chart at a certain point in time, of an investment topic. The prediction entry part 512b includes vote input parts 512c for generating vote data regarding a price movement of an investment topic. That is, the prediction entry part 512b is a “first screen area”.

Vote input parts 512C

The vote input parts 512c are an upward movement prediction input part 512cl for selecting a price increase in an investment topic and a downward movement prediction input part 512c2 for selecting a price decrease in the investment topic. The user, therefore, can enter only either an upward movement prediction or a downward movement prediction using the user terminal 300. Once data is transmitted to the server 200, the user can no longer transmit data on that day. An upward movement prediction and a downward movement prediction are predictions indicating whether a closing price of a market on a day of vote entry is higher or lower than that on a previous day.

The prediction entry part 512b further includes predicted value entry parts 512d, where the user can enter predicted values of an investment topic.

Predicted Value Entry parts 512d

In the example illustrated in FIG. 5, the predicted value entry parts 512d include a first entry part 512d1 for “Predicted value one week later” and a second entry part 512d2 for “Predicted value one month later”. “One week later” and “one month later” are examples, and other periods of time may be added or used instead of these. Once the user terminal 300 transmits data to the server 200, the user terminal 300 can no longer transmit data again on that day.

The predicted value entry parts 512d further include a prediction reason entry part 512d3, where the user can enter a reason for a prediction of a predicted value. In the prediction reason entry part 512d3, the user can freely enter text. The user can enter predicted values with a prediction reason and disclose the entered data to other users. The user, however, need not necessarily enter data in the prediction reason entry part 512d3.

### Prediction Transmission Part 512e

The predicted value entry parts 512d further include a prediction transmission part 512e for transmitting predicted values and a prediction reason to the server 200. Since the user need not necessarily enter a prediction reason, the user can transmit data to the server 200 after entering at least a predicted value, that is, data in the first input field 512d1 or the second input field 512d2. The data received by the server 200 is stored in the predicted value data storage section 244 and the prediction reason data storage section 245 as “predicted value data” and “prediction reason data”, respectively.

### Third Display Area 503

The third display area 503 includes post display parts 513 for displaying posts obtained by the server 200 from the user terminals 300. In each post display part 513, a name of a user who has made a corresponding post is displayed at a top, and part of posted text data is displayed below the name (indicated by horizontal lines). In each post display part 513, a user icon 513a of the user who has made the corresponding post, a favorite input part 513b, a comment input part 513c, and a share input part 513d are also provided.

By clicking the user icon 513a, the user can follow another user corresponding to the user icon 513a. The user icon 513a, therefore, functions as a follow input part. Data received by the server 200 is stored in the follow data storage section 250 as “follow data”.

By clicking the favorite input part 513b, the user can favorite a corresponding post. Data received by the server 200 is stored in the favorite data storage section 249 as “favorite data”.

By clicking the comment input part 513c, the user can enter a comment in a displayed comment entry field and transmit the comment to the server 200. Data received by the server 200 is stored in the comment data storage section 247 as “comment data”.

By clicking the share input part 513d, the user can share a corresponding post with followers thereof or other persons. When the server 200 receives a share command, the server 200 stores the command in the shared data storage section 248 as “share data”.

### Fourth Display Area 504

A fourth display area 504 is provided above the first display area 501, the second display area 502, and the third display area 503. The fourth display area 504 includes a search entry part 514 and a notification setting part 515. The search entry part 514 can be used to perform a keyword search for data stored in the storage unit 202. The notification setting part 515 is provided as a link button for displaying a notification setting screen for the user terminal 300. A method for setting notifications using the notification setting part 515 will be described later.

### Top Page

Although not illustrated, the top page may include the second display area 502 where a timeline including, from a top, the post entry part 511, at least one vote input part 512c, and a plurality of posts and current news is displayed, as well as the first display area 501 and the third display area 503.

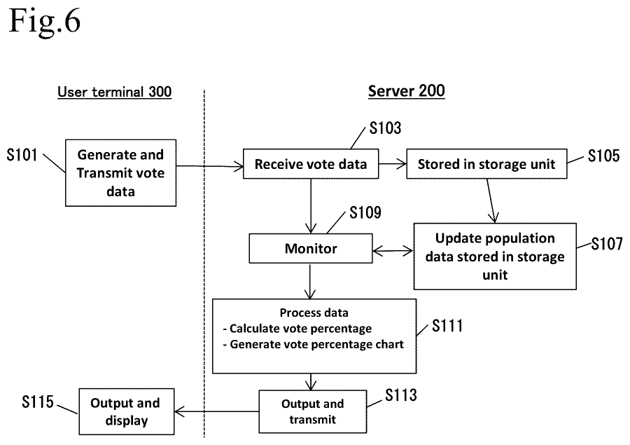

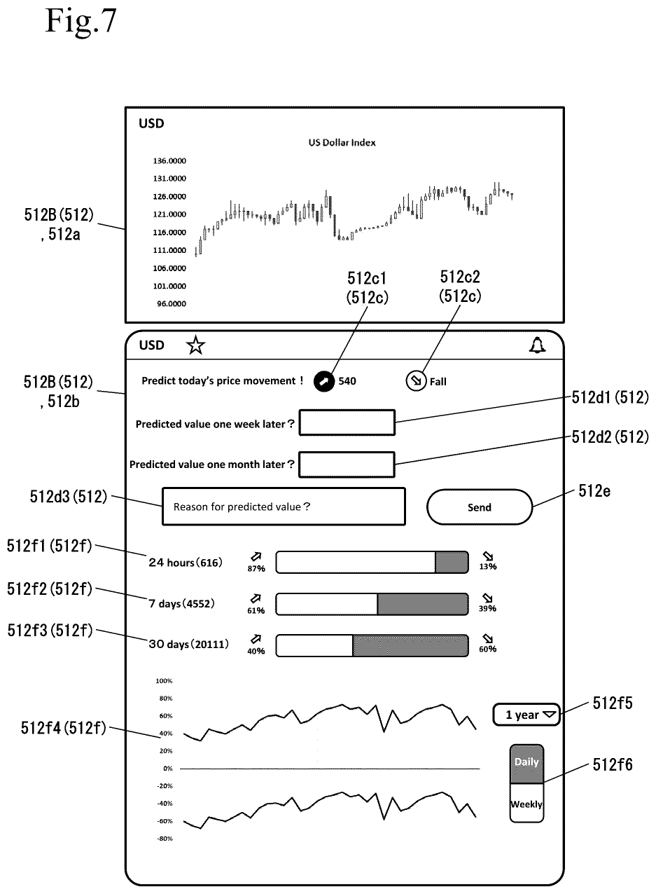

### [6] Providing Information (FIGS. 6 and 7)

Examples of methods for providing information performed by the information provision system 100 will be described. A method for providing information and functions relating to voting, a method for providing information and functions relating to a predicted value, and a method for providing information and functions based on a notification will be described hereinafter.

### [6.1] Method for Providing Information and Functions Relating to Voting (FIGS. 5 to 7)

FIG. 5, a flowchart of FIG. 6, and FIG. 7 will be referred to hereinafter.

Generation and Transmission of Vote data

When the user clicks the upward movement prediction input part 512cl or the downward movement prediction input part 512c2 of the vote input parts 512c illustrated in FIG. 5 on the user terminal 300, the input unit 302 receives the operation. The control unit 301 generates vote data in accordance with an upward movement prediction or a downward movement prediction (S101 in FIG. 6). The control unit 301 transmits the generated vote data to the server 200 through the communication unit 306.

### Update of Population Data

The obtaining section 211 of the server 200 receives the vote data (S103), and the vote data storage section 243 of the storage unit 202 stores the vote data (S105). Vote data obtained from a large number of user terminals 300 is accumulated in the vote data storage section 243. Each time the control unit 201 obtains new vote data, therefore, the control unit 201 causes the storage unit 202 to update population data accumulated in the vote data storage section 243 (S107). A “time of voting” herein and in the claims may be a time when the server 200 stores vote data received from a user terminal 300 in the vote data storage section 243 of the storage unit 202. This, however, is an example, and the “time of voting” may be a time when one of the vote input parts 512c is clicked using the input unit 302 of a user terminal 300 or a time when the obtaining section 211 of the server 200 receives vote data from a user terminal 300.

### Monitoring and Process for Calculating Vote Percentage

The monitoring section 212 of the control unit 201 monitors whether the population data is updated (S109). When the monitoring section 212 detects update of the population data, the data processing section 214 of the control unit 201 performs a process for calculating vote percentage (S111).

The population data is a total number of votes cast. As upward movement prediction data increases, vote percentage of upward movement predictions relative to the total number of votes cast increases. As downward movement prediction data increases, vote percentage of downward movement predictions relative to the total number of votes cast increases. The data processing section 214 calculates the vote percentage of upward movement predictions and the vote percentage of downward movement predictions with the total number of votes cast determined as 100%. The data processing section 214 generates a result of the calculation of the vote percentage as “vote result data”.

### Generation of Vote Percentage Chart

The data processing section 214 transmits vote result data to the chart generation portion 221. The chart generation portion 221 generates a vote percentage chart 512f indicating changes in the vote percentage within a certain voting period on the basis of the vote result data (S111). The control unit 201 transmits the vote percentage chart 512f to the output section 215. The screen transmission portion 231 of the output section 215 transmits data including the vote percentage chart 512f to the user terminal 300 as a “second screen area” (S113).

The control unit 301 of the user terminal 300 transmits, to the output processing unit 305, the data received through the communication unit 306 and displays the data by updating a prediction entry part 512b of topic display areas 512 (S115).

Update of Topic Display Areas after Voting

FIG. 7 illustrates an example of a state where the second topic display areas 512B have been updated after voting on price movement predictions for U.S. dollar illustrated in FIG. 5 is performed. The second topic display areas 512B are updated in the same manner for investment topics as for U.S. dollar. FIG. 7 illustrates only the second topic display areas 512B in the second display area 502.

If a vote for an upward movement prediction is cast, color of the upward movement prediction input part 512cl is inverted after the voting, and the number of votes cast so far for upward movement predictions is displayed. The same holds for a case where a vote for a downward movement prediction is cast. A plurality of vote percentage charts 512f are displayed below the prediction reason entry part 512d3. Although FIG. 7 illustrates four vote percentage charts 512f in the present embodiment, the number of vote percentage charts 512f may be two or four or more, instead. The four vote percentage charts 512f are “vote percentage charts within a plurality of voting periods”. The “voting periods” may be any other periods, instead.

A first vote percentage chart 512f is a 24-hour vote percentage chart 512f1. This chart indicates vote percentage using, as population data, a total number of votes cast in 24 hours prior to a time when the population data is updated. This is a horizontal 100% stacked bar graph where upward movement predictions are represented on a left side and downward movement predictions are represented on a right side. A ratio of the upward movement predictions to the downward movement predictions is expressed in percentage. “(616)” beside “24 hours” indicates the population data, that is, the total number of votes cast.

A second vote percentage chart 512f is a 7-day vote percentage chart 512f2. This chart indicates vote percentage using, as population data, the total number of votes cast in seven days prior to the time when the population data is updated. The 7-day vote percentage chart 512f2 is the same as the 24-hour vote percentage chart 512f1 in other respects.

A third vote percentage chart 512f is a 30-day vote percentage chart 512f3. This chart indicates vote percentage using, as population data, the total number of votes cast in 30 days prior to the time when the population data is updated. The 30-day vote percentage chart 512f3 is the same as the 24-hour vote percentage chart 512f1 in other respects.

A fourth vote percentage chart 512f is a line graph 512f4 indicating changes in vote percentage. A vertical axis of the graph represents percentage, and a horizontal axis is a time axis. The vertical axis indicates 0% at an intersection with the horizontal axis. That is, an area above the horizontal axis represents vote percentage of upward movement predictions, and an area below the horizontal axis represents vote percentage of downward movement predictions. By clicking a display period change part 512f5, the output processing unit 305 can change time represented by the horizontal axis of the line graph 512f4 to past one year, six months, three months, or the like. These periods of time represented by the horizontal axis are examples, and other periods of time may be used, instead. By clicking a daily/weekly switching part 512f6, the output processing unit 305 can switch the line graph 512f4 between daily representation and weekly representation. When a cursor is moved over the line graph 512f4, a date and values of the vote percentage of upward movement predictions and downward movement predictions are displayed in a popup window. The values of the vote percentage of upward movement predictions and downward movement predictions can be displayed in units of days in the case of the daily representation and in units of weeks in the case of the weekly representation.

### [6.2] Method for Providing Information and Functions Relating to Predicted Value (FIGS. 5, 8, and 9)

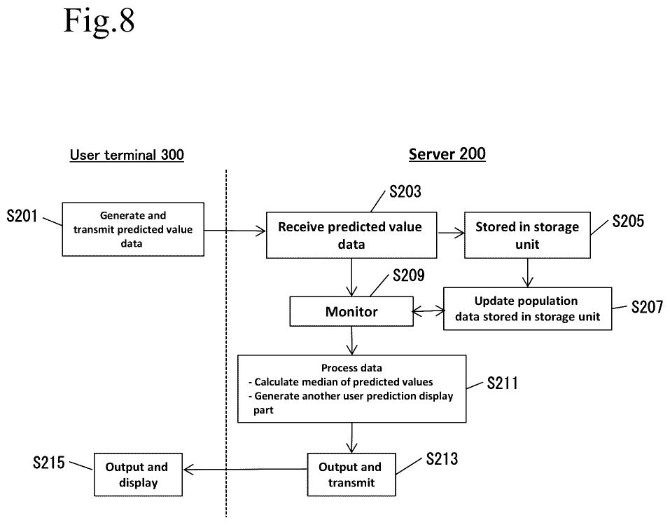

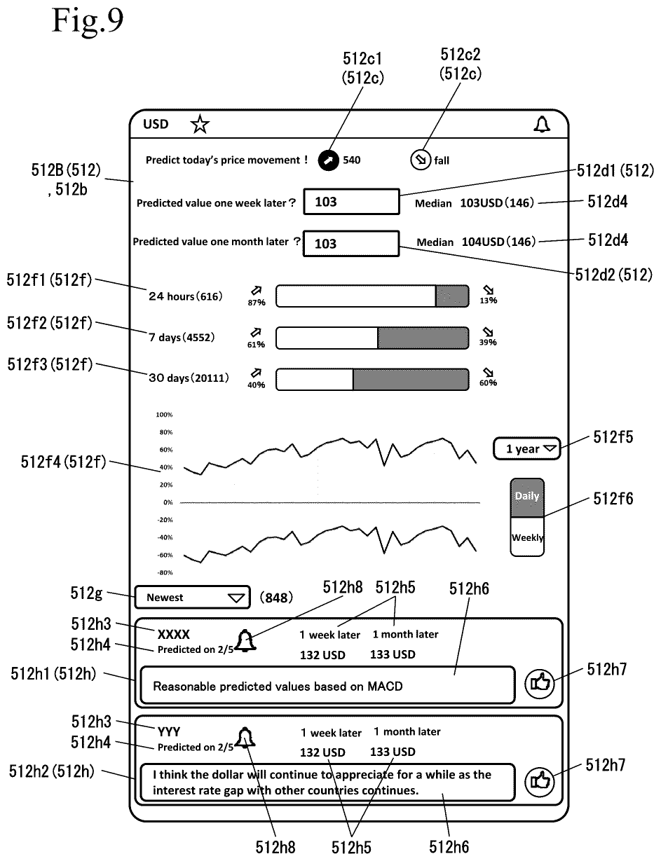

FIG. 5, a flowchart of FIG. 8, and FIG. 9 will be referred to hereinafter.

### Generation and Transmission of Predicted Value Data

The user enters, using the user terminal 300, a predicted value in the first entry part 512d1 or the second entry part 512d2 of the predicted value entry parts 512d illustrated in FIG. 5, and the input unit 302 receives the predicted value. If the user enters a prediction reason in the prediction reason entry part 512d3, the input unit 302 also receives the prediction reason. The control unit 301 generates predicted value data and prediction reason data and transmits the predicted value data and the prediction reason data to the server 200 through the communication unit 306 (S201 in FIG. 8). Since the user need not necessarily enter a prediction reason, prediction reason data is not generated or transmitted to the server 200 if the user does not enter a prediction reason. A case where prediction reason data is generated will be described hereinafter.

### Update of Population Data

The obtaining section 211 of the server 200 receives predicted value data (S203) and stores the predicted value data in the predicted value data storage section 244 of the storage unit 202 (S205). The prediction reason data is stored in the prediction reason data storage section 245 of the storage unit 202 (S205). Predicted value data and prediction reason data obtained from a large number of user terminals 300 are accumulated in the predicted value data storage section 244 and the prediction reason data storage section 245, respectively. Each time the control unit 201 obtains new predicted value data and new prediction reason data from a user terminal 300, therefore, the control unit 201 causes the storage unit 202 to update the population data accumulated in the predicted value data storage section 244 and the prediction reason data storage section 245 (S207).

### Monitoring and Process for Calculating Median of Predicted Values

The monitoring section 212 of the control unit 201 monitors whether the population data is updated (S209). If the monitoring section 212 detects update of the population data, the data processing section 214 of the control unit 201 performs a process for calculating a median of predicted values (S211). The process for calculating a median of predicted values is performed using, as population data, data in 24 hours prior to the time when the population data is updated.

The screen generation portion 222 of the control unit 201 generates another user prediction display parts 512h including another user prediction information, which includes predicted values and prediction reasons entered by other users in the past for the same investment topic (S211).

The control unit 201 transmits the median of predicted values and the another user prediction display parts 512h to the output section 215. The screen transmission portion 231 of the output section 215 transmits data including the median of predicted values and the another user prediction display parts 512h to the user terminal 300 as a “second screen area” (S213).

The control unit 301 of the user terminal 300 transfers the data received through the communication unit 306 to the output processing unit 305 to display the data by updating the prediction entry part 512b of the topic display areas 512 (S215).

### Update of Topic Display Areas After Predicted Value Is Entered

FIG. 9 illustrates an example of a state where predicted values of U.S. dollar illustrated in FIG. 5 have been entered and the screen generation portion 222 has updated the prediction entry part 512b of the second topic display areas 512B. FIG. 9 illustrates only the prediction entry part 512b of the second topic display areas 512B in the second display area 502.

After predicted values are entered, medians 512d4 of predicted values are displayed to the right of the predicted value entry parts 512d. Although not illustrated, not only the medians 512d4 but also median charts may be displayed. The median charts may be line graphs where a vertical axis represents price (value) and a horizontal axis is a time axis. The median charts can display predictions one week later and predictions one month later with different line graphs.

A sorting selection part 512g and another user prediction display parts 512h are displayed below a line graph 512f4.

The sorting selection part 512g is used to rearrange a plurality of pieces of another user prediction information 512h1 and 512h2 included in the another user prediction display parts 512h. The sorting portion 225 performs the rearrangement. The pieces of another user prediction information 512h1 and 512h2 can be sorted, for example, newest first or oldest first, in ascending or descending order of evaluation of a user, and/or in ascending or descending order of a predicted value. A value to the right of the sorting selection part 512g indicates the number of pieces of another user prediction information.

The pieces of another user prediction information 512h1 and 512h2 include usernames 512h3 (“XXXX” and “YYY” in FIG. 9), prediction dates 512h4 (“Predicted on 2/5”), predicted values 512h5 (predicted values one week later “132 USD” and predicted values one month later “133 USD”), prediction reasons 512h6 (“Reasonable predicted values based on MACD” and “I think the dollar will continue to appreciate for a while as the interest rate gap with other countries continues”), favorite input parts 512h7, and user prediction notification setting parts 512h8. By referring to these another user prediction display parts 512h, the user can easily obtain multiple perspectives and information from other users on investment topics.

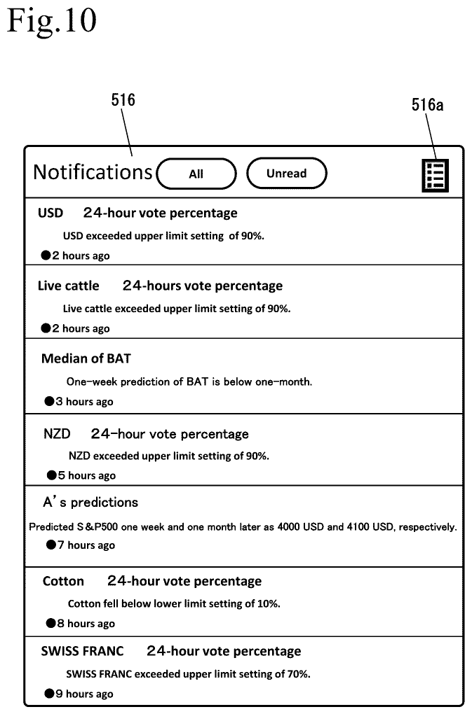

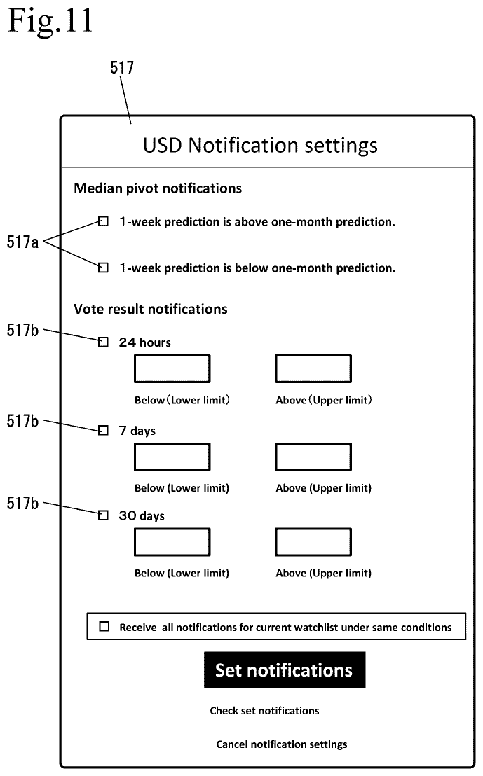

### [6.3] Method for Providing Information and Functions Based on Notification (FIGS. 10 and 11)

By clicking the notification setting part 515 in the fourth display area 504 illustrated in FIG. 5, a notification screen 516 illustrated in FIG. 10 is displayed. In the notification screen 516, notifications whose notification settings have been made are displayed as a list. Although seven notifications are illustrated here, other notifications may also be displayed by scrolling down the notification screen 516. The seven illustrated notifications include five notifications about vote percentage, one notification about a median of predicted values, and one notification about another user's predicted values. The notification settings, such as those for vote percentage, a median of predicted values, and another user's predicted values, will be specifically described.

The notification screen 516 illustrated in FIG. 10 is provided with a notification setting selection part 516a. By clicking the notification setting selection part 516a, link items “(A) Notification Settings”, “(B) Chart Notification Settings”, and “(C) Open Notification Page” are displayed.

In “(A) Notification Settings”, types of notification to be received can be selected. Examples of selectable notification items include user prediction notifications, media pivot notifications, vote percentage alerts, favorite notifications, share notifications, profile view notifications, featured post notifications, post-related notifications, comment-related notifications, and follow notifications.

In “(B) Chart Notification Settings”, notifications relating to charts can be set. Selectable notification items may include a vote percentage chart notification, a median pivot notification, and a user prediction notification. The notifications relating to charts can be set, as illustrated in FIG. 11, in a notification setting screen 517 that identifies an investment topic. The notification setting screen 517 can be accessed from the notification setting selection part 516a but can also be displayed by clicking one of notification setting parts 512i in the prediction entry parts 512b illustrated in FIG. 5.

In the notification setting screen 517 illustrated in FIG. 11, “Median Pivot Notifications” 517a and “Vote Result Notifications” 517b (vote percentage chart notifications) can be set. These will be specifically described later.

With “(C) Open Notification Page”, a list of a plurality of notifications is displayed as illustrated in FIG. 10.

The vote percentage chart notifications, the median pivot notifications, and the user prediction notifications will be described hereinafter.

### Vote Result Notifications (Vote Percentage Chart Notifications)

In the vote result notifications, a threshold is set for each of the predicted values (24 hours, 7 days, and 30 days) of vote percentage, and the server 200 notifies the user terminal 300 of a predicted value exceeding the corresponding threshold. The threshold is a lower limit value or an upper limit value of the corresponding predicted value. The user can set a condition under which a notification is issued, that is, whether a predicted value falls below the lower limit value or exceeds the upper limit value. By checking one of checkboxes 517b in the notification setting screen 517 illustrated in FIG. 11, the user can set a corresponding notification, and by unchecking one of the checkboxes 517b, the user can cancel a corresponding notification.

### First Example of Notification Settings

Notification target: A result of voting on a certain investment topic carried out in past 24 hours
Notification condition: A lower limit value or an upper limit value of vote percentage of upward movement predictions or downward movement predictions
Example of notification settings: When the user has voted that a price of the investment topic will rise, the user terminal 300 is notified if a lower limit value of vote percentage of upward movement predictions exceeds 10% or an upper limit value of vote percentage of upward movement predictions exceeds 30% within 24 hours after the voting.

### Second Example of Notification Settings

Notification target: A result of voting on a certain investment topic carried out in past 7 days
Notification condition: A lower limit value or an upper limit value of vote percentage of upward movement predictions or downward movement predictions
Example of notification settings: When the user has voted that a price of the investment topic will fall, the user terminal 300 is notified if a lower limit value of vote percentage of downward movement predictions exceeds 10% or an upper limit value of vote percentage of upward movement predictions exceeds 30% within 7 days after the voting.

### Third Example of Notification Settings

Notification target: A result of voting on a certain investment topic carried out in past 30 days
Notification condition: A lower limit value or an upper limit value of vote percentage of upward movement predictions or downward movement predictions
Example of notification settings: When the user has voted that a price of the investment topic will fall, the user terminal 300 is notified if a lower limit value of vote percentage of downward movement predictions exceeds 10% or an upper limit value of vote percentage of upward movement predictions exceeds 30% within 30 days after the voting.

### Median Pivot Notifications

The median pivot notifications are a function of receiving, as notifications, predictions one week later and predictions one month later of a median chart of predicted values of an investment topic on a previous day. By checking one of checkboxes 517a in the notification setting screen 517 illustrated in FIG. 11, the user can set a corresponding notification, and by unchecking one of the checkboxes 517a, the user can cancel a corresponding notification.

### User Prediction Notifications

The user prediction notifications are a function of receiving notifications about predicted values and prediction reasons entered by other users. A third notification from a bottom (“A's predictions”) in the notification screen 516 illustrated in FIG. 10 is a user prediction notification. The pieces of another user prediction information 512h1 and 512h2 illustrated in FIG. 9 include user prediction notification setting parts 512h8. By clicking one of the user prediction notification setting parts 512h8, a corresponding notification can be received.

### User Vote Notifications

User vote notifications are a function of receiving notifications about upward movement predictions or downward movement predictions voted for by other users.

### User Group Prediction Notifications

User group prediction notifications are a function receiving notifications about predicted values of a plurality of other users grouped by the user as desired. Data regarding user groups is stored in the group data storage section 252 of the server 200. Notifications about predicted values of individual users included in a user group can be received, or notifications about a median or an average of predicted values of a user group can be received.

### User Group Vote Notifications

User group vote notifications are a function of receiving notifications about vote results of a plurality of other users grouped by the user as desired. Data regarding user groups is stored in the group data storage section 252 of the server 200. Notifications about vote results of individual users included in a user group can be received, or notifications about vote percentage (a ratio of upward movement predictions to downward movement predictions) of vote results of a user group can be received.

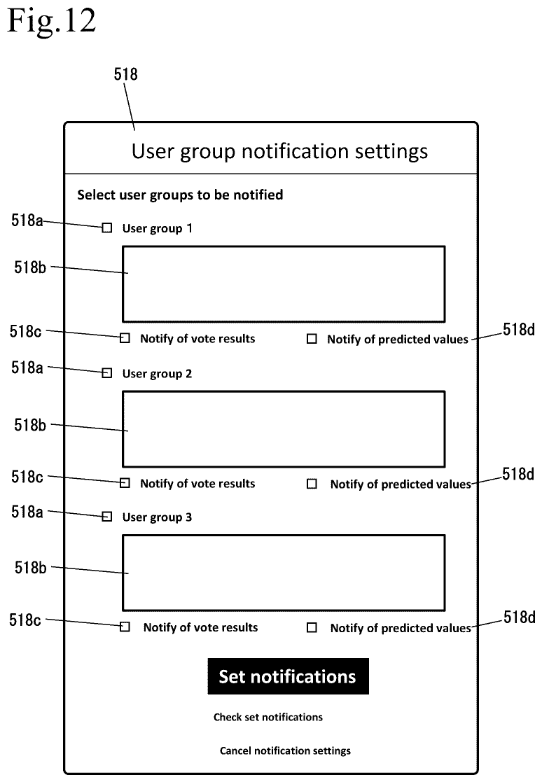

FIG. 12 is a user group setting screen 518 for setting the user group prediction notifications and the user group vote notifications. Although FIG. 12 illustrates an example where three user groups 1 to 3 can be set, any number of user groups may be set. The user group setting screen 518 may include group selection parts 518a, group member display parts 518b, group vote notification setting parts 518c, and group predicted value notification setting parts 518d.

By checking or unchecking checkboxes of the group selection parts 518a, the user can select user groups 1 to 3 as notification targets or cancel selection of user groups 1 to 3. Usernames included in user groups 1 to 3 are displayed in the corresponding group member display parts 518b. By checking or unchecking checkboxes of the group vote notification setting parts 518c and the group predicted value notification setting parts 518d, the user can select notifications or cancel selection of the notifications.

### [7] Effects According to Embodiment

Effects according to the embodiment of the present disclosure, including those that have already been described, will be described.

A first aspect of the present disclosure is a method for providing information regarding an investment topic for user terminals 300 using a server 200, the method including transmitting, using the server 200, a prediction entry part 512b as a “first screen area” including a vote input part 512c for generating vote data regarding a price movement of one or more investment topics to each of the user terminals 300, receiving, using the server 200, the vote data from the user terminals 300, the vote data including either an upward movement prediction, which indicates a price increase of the one or more investment topics, or a downward movement prediction, which indicates a price decrease of the one or more investment topics, generating, using the server 200, vote result data, which is a result of comparison between upward movement predictions and downward movement predictions based on the vote data received from the user terminals 300, and transmitting, using the server 200, a “second screen area” including the vote result data to the user terminal 300. A second aspect of the present disclosure is a program including instructions to execute the method using the server 200. A third aspect of the present disclosure is a non-transitory computer-readable storage medium including instructions to execute the method using the server 200.

As a result, each user can know, as vote result data provided by the server 200, results of predictions (upward movement predictions or downward movement predictions) made by a large number of users (user terminals 300) regarding price movements of investment topics. A trend of the users' predictions can be an opportunity for each user to notice oversights of important information, overestimation or underestimation of information, and the like. Each user can thus use predictions made by a large number of other users for his/her own investment decisions.

The vote result data included in the second screen area may include one or more vote percentages indicating the upward movement predictions and the downward movement predictions in one or more voting periods prior to a time of voting. Since a user terminal 300 can obtain vote percentage, a user who uses the user terminal 300 can know predictions made by a large number of other users (user terminals 300) regarding price movements of investment targets.

The vote result data may include a vote percentage chart indicating changes in the one or more vote percentages in the one or more voting periods. A user who uses a user terminal 300 can easily understand, from the vote percentage chart provided by the server 200, temporal changes in predictions (prediction trend) made by a large number of other users (user terminals 300).

The first screen area may include a predicted value entry part 512d, where a predicted value of the one or more investment topics is entered. In this case, the server 200 can collect specific predicted values of investment topics from a large number of users (user terminals 300). The collected predicted values can be used by a large number of users (user terminals 300) as reference information for investment decisions.

The predicted value entry part 512d may include a prediction reason entry part 512d3, where a prediction reason for the predicted value is entered. In this case, the server 200 can collect prediction reasons for upward movement predictions or downward movement predictions from a large number of users (user terminals 300). The collected prediction reasons can be used by a large number of users (user terminals 300) as reference information for investment decisions.

The second screen area may include another user prediction display part 512h including another user prediction information, which includes the predicted value and the prediction reason from one or more other users. In this case, not only vote result data but also predicted values and prediction reasons entered by other users, which are more specific information, can be known. A user (user terminal 300), therefore, can collect perspectives of other investors' investment decisions.

The server 200 may display a plurality of pieces of the another user prediction information included in the another user prediction display part 512h while sorting the plurality of pieces of the another user prediction information newest first or oldest first, in ascending or descending order of evaluation of a user, and/or in ascending or descending order of a predicted value. In this case, convenience of information gathering can be increased for a user.

The server 200 may receive a notification setting from each of the user terminals 300, the notification setting including a lower limit value or an upper limit value of the one or more vote percentages in the one or more voting periods, and transmit a notification to the user terminal 300 on a basis of the notification setting. Furthermore, the server 200 may receive a notification setting from each of the user terminals 300, the notification setting including a lower limit value or an upper limit value of the predicted value, and transmit a notification to the user terminal 300 on a basis of the notification setting. In this case, by making it possible to grasp changes in thinking of a large number of users (user terminals 300) regarding price movement predictions (changes in upward movement predictions and downward movement predictions, changes in vote percentage, and changes in predicted values) in real time through notifications, individual investors (users) can quickly and easily access the events that have occurred.

The server 200 may receive a notification setting from each of the user terminals 300, the notification setting including reception, by the server 200, of the vote data from one or more other users, and transmit a notification to the user terminal 300 on a basis of the notification setting. In this case, a user can know, for example, that a particular user he/she is focusing on has voted, and can use this as an opportunity to consider his/her own investment decisions.

The server 200 may receive a notification setting from each of the user terminals 300, the notification setting including reception, by the server 200, of the predicted value from one or more other users, and transmit a notification to the user terminal 300 on a basis of the notification setting. In this case, a user can know, for example, that a particular user he/she is focusing on has entered a predicted value, and can use this as an opportunity to consider his/her own investment decisions.

The server 200 may receive a notification setting from each of the user terminals 300, the notification setting including reception, by the server 200, of a prediction reason for the predicted value from one or more other users, and transmit a notification to the user terminal 300 on a basis of the notification setting. In this case, a user can know, for example, a reason for a predicted value entered by a particular user he/she is focusing on, and can use this as an opportunity to consider his/her own investment decisions.

The notification may include at least an audio notification, a notification through transmission of an email, or a notification based on an image in a website screen or an application screen or a text message. In this case, a user terminal 300 can certainly recognize reception of a notification.

The notification may include at least a notification, to a website screen, an application screen, or a screen of each of the user terminals 300, based on a movie or an animation where a human character or an anthropomorphic character speaks. In this case, since the notification is a movie or an animation where a human character or an anthropomorphic character speaks, a user pays more attention to the notification.

### [8] Modifications

The embodiment is an example for describing embodiments of the present disclosure. The configuration of the information display screen 500 and the arrangement of the elements displayed in the information display screen 500, therefore, are merely examples.

What is claimed is:

1. A method for providing information regarding an investment topic for user terminals using a server, the method comprising:
transmitting, using the server, a first screen area including a vote input part for generating vote data regarding a price movement of one or more investment topics to each of the user terminals;
receiving, using the server, the vote data from the user terminals, the vote data including either an upward movement prediction, which indicates a price increase of the one or more investment topics, or a downward movement prediction, which indicates a price decrease of the one or more investment topics;
generating, using the server, vote result data, which is a result of comparison between upward movement predictions and downward movement predictions based on the vote data received from the user terminals; and
transmitting, using the server, a second screen area including the vote result data to the user terminal.

2. The method according to claim 1,
wherein the vote result data included in the second screen area includes one or more vote percentages indicating the upward movement predictions and the downward movement predictions in one or more voting periods prior to a time of voting.

3. The method according to claim 2,
wherein the vote result data includes a vote percentage chart indicating changes in the one or more vote percentages in the one or more voting periods.

4. The method according to claim 1,
wherein the first screen area includes a predicted value entry part, where a predicted value of the one or more investment topics is entered.

5. The method according to claim 4,
wherein the predicted value entry part includes a prediction reason entry part, where a prediction reason for the predicted value is entered.

6. The method according to claim 5,
wherein the second screen area includes another user prediction display part including another user prediction information, which includes the predicted value and the prediction reason from one or more other users.

7. The method according to claim 6, further comprising:
displaying, using the server, a plurality of pieces of the another user prediction information included in the another user prediction display part while sorting the plurality of pieces of the another user prediction information newest first or oldest first, in ascending or descending order of evaluation of a user, and/or in ascending or descending order of a predicted value.

8. The method according to claim 2, further comprising:
receiving, using the server, a notification setting from each of the user terminals, the notification setting including a lower limit value or an upper limit value of the one or more vote percentages in the one or more voting periods; and
transmitting, using the server, a notification to the user terminal on a basis of the notification setting.

9. The method according to claim 4, further comprising;
receiving, using the server, a notification setting from each of the user terminals, the notification setting including a lower limit value or an upper limit value of the predicted value; and
transmitting, using the server, a notification to the user terminal on a basis of the notification setting.

10. The method according to claim 1, further comprising:
receiving, using the server, a notification setting from each of the user terminals, the notification setting including reception, by the server, of the vote data from one or more other users; and
transmitting, using the server, a notification to the user terminal on a basis of the notification setting.

11. The method according to claim 4, further comprising:
receiving, using the server, a notification setting from each of the user terminals, the notification setting including reception, by the server, of the predicted value from one or more other users; and
transmitting, using the server, a notification to the user terminal on a basis of the notification setting.

12. The method according to claim 5, further comprising:
receiving, using the server, a notification setting from each of the user terminals, the notification setting including reception, by the server, of a prediction reason for the predicted value from one or more other users; and
transmitting, using the server, a notification to the user terminal on a basis of the notification setting.

13. The method according to claim 8,
wherein the notification includes at least an audio notification, a notification through transmission of an email, or a notification based on an image in a website screen or an application screen or a text message.

14. The method according to claim 8,
wherein the notification includes at least a notification, to a website screen, an application screen, or a screen of each of the user terminals, based on a movie or an animation where a human character or an anthropomorphic character speaks.

15. A program causing a computer to operate as a server that provides information regarding an investment topic for user terminals, the program including instructions to perform a process comprising:
transmitting a first screen area including a vote input part for generating vote data regarding a price movement of one or more investment topics to each of the user terminals;
receiving the vote data from the user terminals, the vote data including either an upward movement prediction, which indicates a price increase of the one or more investment topics, or a downward movement prediction, which indicates a price decrease of the one or more investment topics;
generating vote result data, which is a result of comparison between upward movement predictions and downward movement predictions based on the vote data received from the user terminals; and
transmitting a second screen area including the vote result data to the user terminal.

16. A non-transitory computer-readable storage medium storing a program causing a computer to operate a server that provides information regarding an investment topic for user terminals, the program including instructions to perform a process comprising:
transmitting a first screen area including a vote input part for generating vote data regarding a price movement of one or more investment topics to each of the user terminals;
receiving the vote data from the user terminals, the vote data including either an upward movement prediction, which indicates a price increase of the one or more investment topics, or a downward movement prediction, which indicates a price decrease of the one or more investment topics;
generating vote result data, which is a result of comparison between upward movement predictions and downward movement predictions based on the vote data received from the user terminals; and
transmitting a second screen area including the vote result data to the user terminal.
